(19) United States
(12) Patent Application Publication
(10) Pub. No.: US 2015/0156391 A1
(43) Pub. Date: Jun. 4, 2015

(54) VEHICLE IMAGE CORRECTION SYSTEM AND METHOD THEREOF

(71) Applicant: Chung-Shan Institute of Science and Technology, Armaments Bureau, M.N.D, Taoyuan County (TW)

(72) Inventors: Cheng-Ming Huang, Taoyuan County (TW); Min-Fang Lo, Taoyuan County (TW)

(73) Assignee: Chung-Shan Institute of Science and Technology, Armaments Bureau, M.N.D, Taoyuan County (TW)

(21) Appl. No.: 14/097,191

(22) Filed: Dec. 4, 2013

(51) Int. Cl. H04N 5/232; H04N 7/18

(52) U.S. Cl. CPC H04N 5/23203; H04N 7/181

(57) ABSTRACT

A motor vehicle image correction system includes an image correction module, an image generating module, an image processing unit and an image display unit. The image correction module is installed at a vehicle periphery and includes a plurality of regularly arranged patterns. The image generating module includes a plurality of image generating units, and each image generating unit is installed on a side of the motor vehicle for generating a corresponding image signal, receiving the image signal, and capturing a characteristic image of the image signal, processing the characteristic image, and generating a processed display signal, such that the image processing unit can adjust the vehicle image device according to the regularly arranged pattern of the image correction module to correct the vehicle image device.

### BACKGROUND OF THE INVENTION

1. Field of Invention

The present invention relates to a motor vehicle image correction system and a method thereof, and more particularly to the motor vehicle image correction system and method applied in a device for correcting vehicle images.

2. Description of Related Art

As our living standard improves, people have increasingly higher demands for safety, and thus safety devices used in motor vehicles have advanced from reverse radars at early stage to present video safety devices to cope with user requirements. However, the installation of the video safety devices usually require experienced technicians to do the job, and the conventional video devices still have the drawbacks such as image distortions and misjudgments caused by failures of determination.

In view of the aforementioned drawbacks of the prior art, the present invention provides a motor vehicle image correction system and a method thereof, wherein an image correction module having a characteristic pattern is installed at a vehicle periphery, and the characteristic pattern is detected to achieve the effect of correcting a motor vehicle image.

### SUMMARY OF THE INVENTION

The present invention overcomes the aforementioned problems by providing a motor vehicle image correction system and a method thereof, wherein an image correction module is installed at a vehicle periphery before any detection takes place, and then the characteristic pattern is detected to achieve the effect of correcting a motor vehicle image.

To achieve the aforementioned objective, the present invention provides a motor vehicle image correction system comprising an image correction module, an image generating module, an image processing unit and an image display unit, wherein the image correction module is installed at a vehicle periphery and includes a plurality of regularly arranged patterns; the image generating module includes a plurality of image generating units, and each image generating unit is installed on each side of the motor vehicle for generating a corresponding image signal; and the image generating unit is provided for receiving the image signal, capturing a characteristic image of the image signal, generating a characteristic image signal, receiving the characteristic image signal, and displaying the characteristic image on the image display unit.

With the regularly arranged pattern of the image correction module, the image processing unit can adjust the vehicle image device according to the regularly arranged pattern, so as to achieve the effect of correcting a vehicle image device.

### BRIEF DESCRIPTION OF THE DRAWINGS

FIG. 1 is a schematic view of a motor vehicle image correction system of the present invention;

FIG. 2 is a flow chart of a motor vehicle image correction system of the present invention;

FIG. 3 is a schematic perspective view of a motor vehicle image correction system according to FIG. 1; and

FIG. 4 is a flow chart of a motor vehicle image correction method of the present invention.

### DETAILED DESCRIPTION OF THE INVENTION

The technical characteristics and objectives of the present invention can be further understood by the following detailed description of preferred embodiments and related drawings.

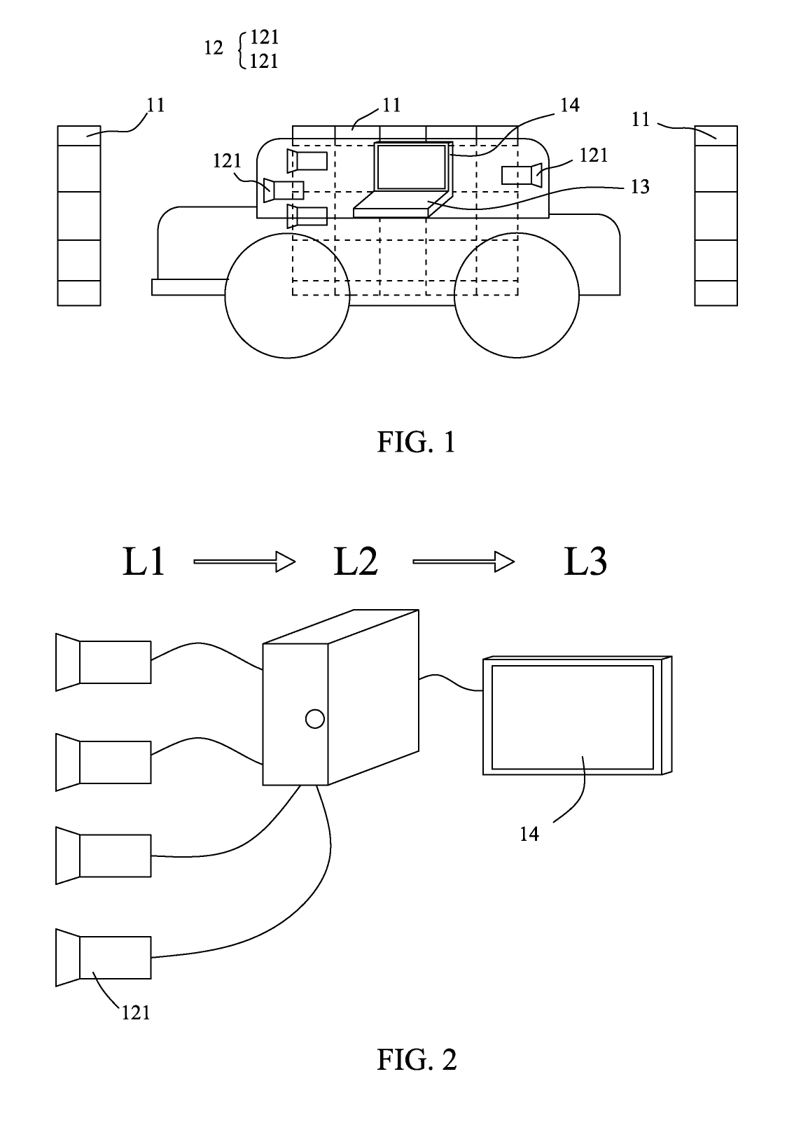

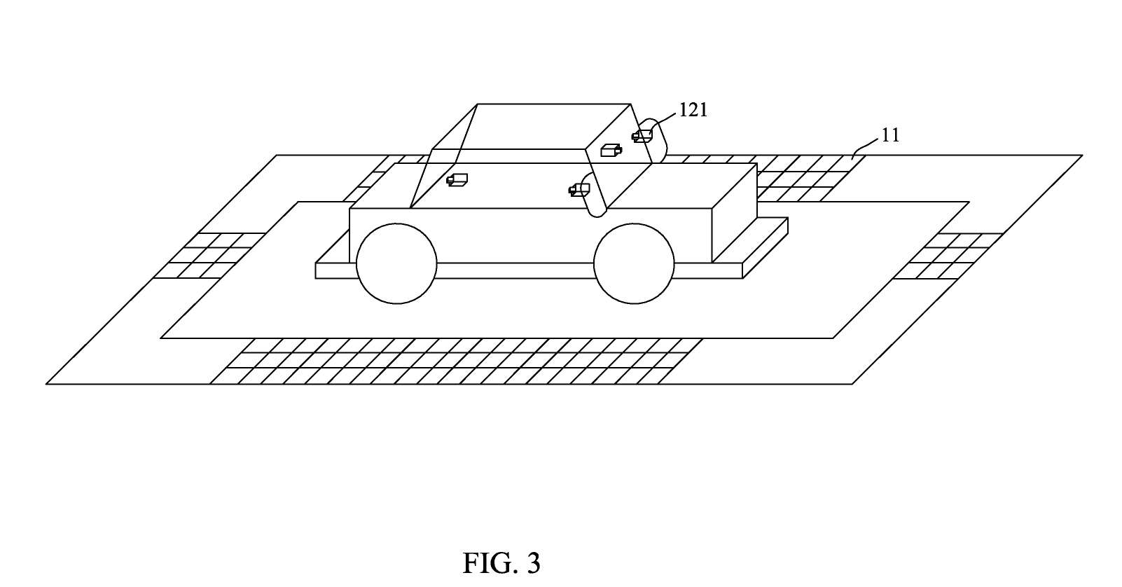

With reference to FIGS. 1 and 2 for the schematic views and a flow chart of a motor vehicle image correction system of the present invention respectively, the system comprises an image correction module 11, an image generating module 12, an image processing unit 13 and an image display unit 14. The image correction module 11 is installed at a vehicle periphery and includes a plurality of regularly arranged patterns, wherein the regularly arranged pattern is in a square shape, a rectangular shape, a circular shape or a triangular shape. The image generating module 12 includes a plurality of image generating units 121, and each image generating unit 121 is installed on a side of the motor vehicle for generating a corresponding image signal L1. For instance, the image generating unit 121 can be a camera installed on a side of the motor vehicle or on a rear mirror of the motor vehicle, as shown in FIG. 3. The image processing unit 13 is provided for receiving the image signal L1 generated by the image generating module 12, capturing a characteristic image L2 of the image signal L1, processing the characteristic image L2, generating a processed display signal L3, and displaying the received the display signal L3 on the image display unit 14, wherein the image processing unit 13 is a computer, and the image display unit 14 is a vehicle liquid crystal display. With the regularly arranged pattern of the image correction module 11, the image processing unit 13 can adjust the vehicle image device according to the regularly arranged pattern, so as to achieve the effect of correcting the vehicle image device.

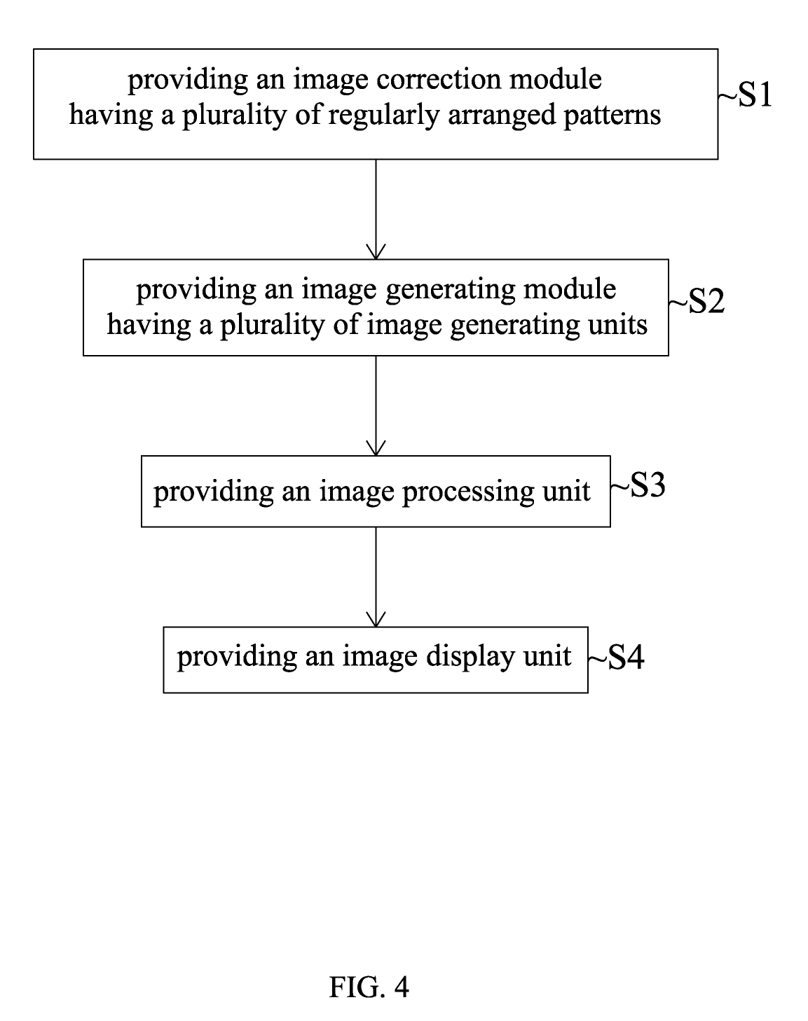

With reference to FIG. 4 for a flow chart of a vehicle image correction method of the present invention, the method comprises the following steps:

S1: Provide an image correction module having a plurality of regularly arranged patterns, and install the image correction module at a vehicle periphery.

S2: Provide an image generating module having a plurality of image generating units, and install the image generating unit on each side of the motor vehicle for generating a corresponding image signal.

S3: Provide an image processing unit for receiving the image signal, capturing a characteristic image of the image signal, processing the characteristic image, and generating a processed display signal.

S4: Provide an image display unit for receiving the display signal and displaying the display signal, such that the image processing unit can adjust the vehicle image device according to the regularly arranged pattern of the image correction module to correct the vehicle image device.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A motor vehicle image correction system, for correcting a vehicle image device, comprising:
an image correction module, installed at a vehicle periphery, and having a plurality of regularly arranged patterns;
an image generating module, including a plurality of image generating units, and each image generating unit being installed on a side of the motor vehicle and provided for generating a corresponding image signal;
an image processing unit, for receiving the image signal, capturing a characteristic image of the image signal, processing the characteristic image, and generating a processed display signal; and
an image display unit, for receiving the display signal, and displaying the display signal, such that the image processing unit can adjust the vehicle image device according to the regularly arranged pattern of the image correction module to correct the vehicle image device.

2. The motor vehicle image correction system of claim 1, wherein the image correction module has a pattern in a square shape, a rectangular shape, a circular shape or a triangular shape.

3. The motor vehicle image correction system of claim 1, wherein the image generating unit is a fisheye lens or a wide-angle lens.

4. The motor vehicle image correction system of claim 1, wherein the image processing unit is a computer.

5. The motor vehicle image correction system of claim 1, wherein the image display unit is a vehicle liquid crystal display.

6. A vehicle image correction method, for correcting a vehicle image device, comprising the steps of,
providing an image correction module having a plurality of regularly arranged patterns, and installing the image correction module at a vehicle periphery;
providing an image generating module having a plurality of image generating units, and installing the image generating unit on each side of the motor vehicle for generating a corresponding image signal;
providing an image processing unit, for receiving the image signal, capturing a characteristic image of the image signal, processing the characteristic image, and generating a processed display signal;
providing an image display unit, for receiving the display signal, and displaying the display signal, such that the image processing unit can adjust the vehicle image device according to the regularly arranged pattern of the image correction module to correct the vehicle image device.

7. The vehicle image correction method of claim 6, wherein the image correction module has a pattern in a square shape, a rectangular shape, a circular shape or a triangular shape.

8. The vehicle image correction method of claim 6, wherein the image generating unit is a fisheye lens or a wide-angle lens.

9. The vehicle image correction method of claim 7, wherein the image processing unit is a computer.

10. The vehicle image correction method of claim 6, wherein the image display unit is a liquid crystal display.
